(19) United States
(12) Patent Application Publication
(10) Pub. No.: US 2003/0046565 A1
(43) Pub. Date: Mar. 6, 2003

(54) Method for encrypting and decrypting contents data distributed through network, and system and user terminal using that method

(75) Inventor: Shigeru Morino, Numazu-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Toshiba Tec Kabushiki Kaisha, Tokyo (JP)

(21) Appl. No.: 09/943,889

(22) Filed: Aug. 31, 2001

(51) Int. Cl. G06F 12/14

(52) U.S. Cl. 713/193

(57) ABSTRACT

A first key is generated at a server from contents information of contents data to be distributed. A second key is generated at the server from a variable parameter, a H/W key ID, and the first key, and then the generated second key is sent to a user terminal. From the variable parameter, the H/W key ID, and the second key, the first key is decrypted at the user terminal. The contents data to be distributed is encrypted by using the first key at the server. The encrypted contents data is sent to the user terminal. The encrypted contents data is decrypted at the user terminal by using the decrypted first key.

### BACKGROUND OF THE INVENTION

1. Field of the Invention

This invention relates to encryption and decryption in distributing contents data from a server through a network.

2. Description of the Related Art

The most widely used method of accessing a data providing service distributed through a network and logging in is to input a user ID and a password.

Both the user ID and the password are sent and received in the form of data through the network. If a third party acquired the user ID and the password through the network by some method and logged in as an authorized user, the server side could not determine whether the customer is an authorized user or not and might permit an illegal access.

To increase the security for logging in, use of a H/W (HARDWARE) key connected to interface ports (parallel, serial, USB ports, or the like) on a personal computer is under consideration. Since the H/W key is difficult to make a copy, a third party other than an authorized user cannot acquire it easily. H/W keys have been used in, for example, extra nets that allow employees to access their in-house database or the services limited to members, such as shopping or banking.

The function of the H/W key is to identify the user easily with high reliability. That is, the main purpose of an authentication system using H/W keys is to protect the authority to issue commands or input data to the programs on the server. For this reason, the authentication system does not protect the contents data distributed from the server through the network. This permits a user terminal to store screen data distributed in an on-line state from the server and later the user can see the data again on the user terminal in an off-line state.

Therefore, when the copyrighted electronic contents data is distributed, it is necessary to prevent the contents data from being reproduced or copied illegally and protect the copyright of the contents data. With this backdrop, contents data reproducing apparatuses with a contents data protecting function have been used in recent years.

Hereinafter, referring to FIG. 5, a contents data reproducing apparatus will be explained.

FIG. 5 shows a functional block diagram showing the configuration of the contents data reproducing apparatus. In FIG. 5, numeral 101 indicates the contents data reproducing apparatus. Numeral 102 indicates an input section for inputting encrypted contents data. Numeral 103 indicates a common key storage section in which common keys for decrypting the encrypted contents data. Numeral 104 indicates a decrypting section for decrypting the encrypted contents data using common keys stored in the common key storage section 103. Numeral 105 indicates a reproducing section for reproducing the contents data so that the contents data may be perceived by the human senses of seeing and hearing or touch or the like.

The operation of the contents data reproducing apparatus 101 configured as described above will be explained below.

First, the encrypted contents data is externally inputted via a communication channel to the input section 102, which sends the inputted data to the decrypting section 104. A common key previously stored in the common key storage section 103 is read and sent to the decrypting section 104. Using the common key that the common key storage section 103 has offered, the decrypting section 104 checks for illegal alterations to the encrypted contents data and decrypts the encrypted contents data. The decrypted data is sent to the reproducing section 105. The reproducing section 105 reproduces the data so that the data may be perceived by the human senses of seeing and hearing or touch or the like and outputs the resulting data.

With the above configuration, however, the same values are used fixedly as the common keys for decrypting the encrypted contents data and are always held in the contents data reproducing apparatus. Therefore, there is a possibility that hackers or the like break into the computer 101 without authorization via a communication channel from the outside and acquire the common key and encrypted contents data. If the common key and contents data are acquired illegally as mentioned above, the data can be reproduced on another apparatus of the same type, leading to an infringement of the copyright of the contents data.

Accordingly, there is a need for a contents data encrypting and decrypting method capable of preventing not only an illegal acquisition of keys for decrypting the encrypted contents data but also an illegal reproduction of the contents data.

### BRIEF SUMMARY OF THE INVENTION

According to an aspect of the present invention, a first key is generated at a server from contents information of contents data to be distributed. A second key is generated at the server from a variable parameter, a H/W key ID, and the first key and the generated second key is sent to a user terminal. From the variable parameter, the H/W key ID, and the second key, the first key is decrypted at the user terminal. The contents data to be distributed is encrypted at the server by using the first key. The encrypted contents data is sent to the user terminal. The encrypted contents data is decrypted at the user terminal by using the decrypted first key.

### BRIEF DESCRIPTION OF THE SEVERAL VIEWS OF THE DRAWING

The accompanying drawings, which are incorporated in and comprise a part of the specification, illustrate presently embodiments of the invention, and together with the general description given above and detailed description of the embodiments given below, serve to explain the principles of the invention.

FIG. 1 is a block diagram to explain an encrypting and decrypting system according to a first embodiment of the present invention;

FIG. 2 shows the configuration of a user terminal in the first embodiment;

FIG. 3 is a flowchart showing the operation of encryption and decryption in the first embodiment;

FIG. 4 is a flowchart for the operation of encryption and decryption in another embodiment of the present invention; and

FIG. 5 shows the configuration of a conventional contents data reproducing apparatus.

### DETAILED DESCRIPTION OF THE INVENTION

Referring to the figures, embodiments of the present invention will be explained below.

(First Embodiment)

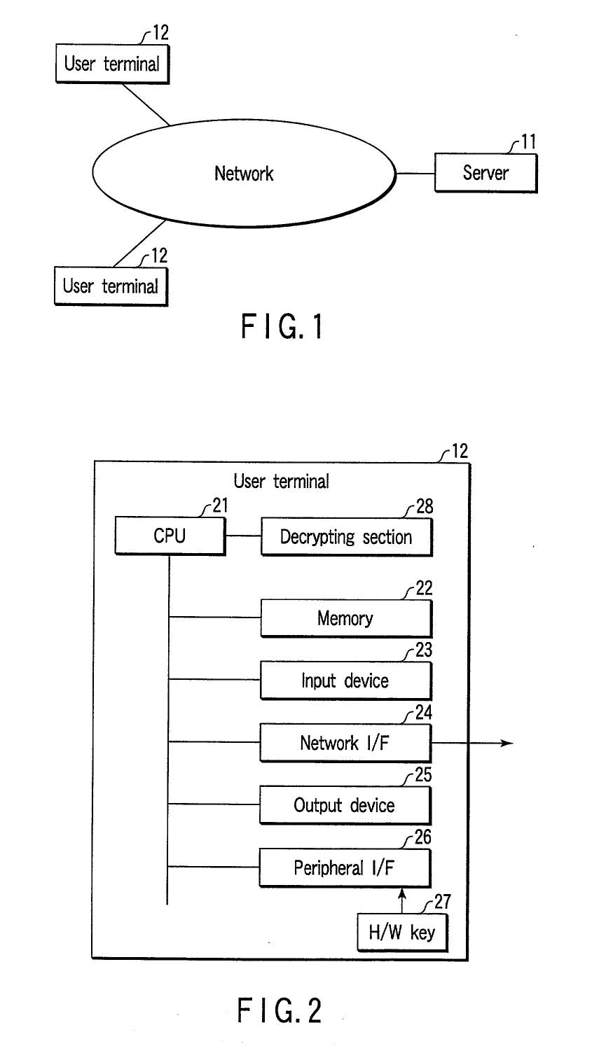

FIG. 1 is a block diagram to explain the total encrypting and decrypting system according to a first embodiment of the present invention. A server 11 is connected to user terminals 12 through a network. The network may be managed by a contents data provider and allowed to be used by only the contracted users or by anyone as found on the Internet.

FIG. 2 shows the configuration of a user terminal 12 used in the first embodiment. The user terminal 12 comprises a CPU 21, a memory 22, an input device 23, a network I/F (interface) 24, an output device 25, a peripheral I/F (interface) 26, and a decrypting section 28.

The memory 22 is composed of a flash memory card, a hard disk drive, ROM, RAM, or the like. The input device 23 is composed of a keyboard, a mouse, or the like. The network I/F 24 is connected to a communication channel outside the user terminal 12, such as a network. The output device 25 is composed of a display or the like. A H/W key 27 is inserted in the peripheral I/F 26. The H/W key 27 is used to prevent an illegal use of the user terminal 12. The user terminal 12 does not operate unless the H/W key 27 of an authorized user is inserted in the user terminal 12. The decrypting section 28 decrypts not only a first key but also the encrypted contents data as explained later.

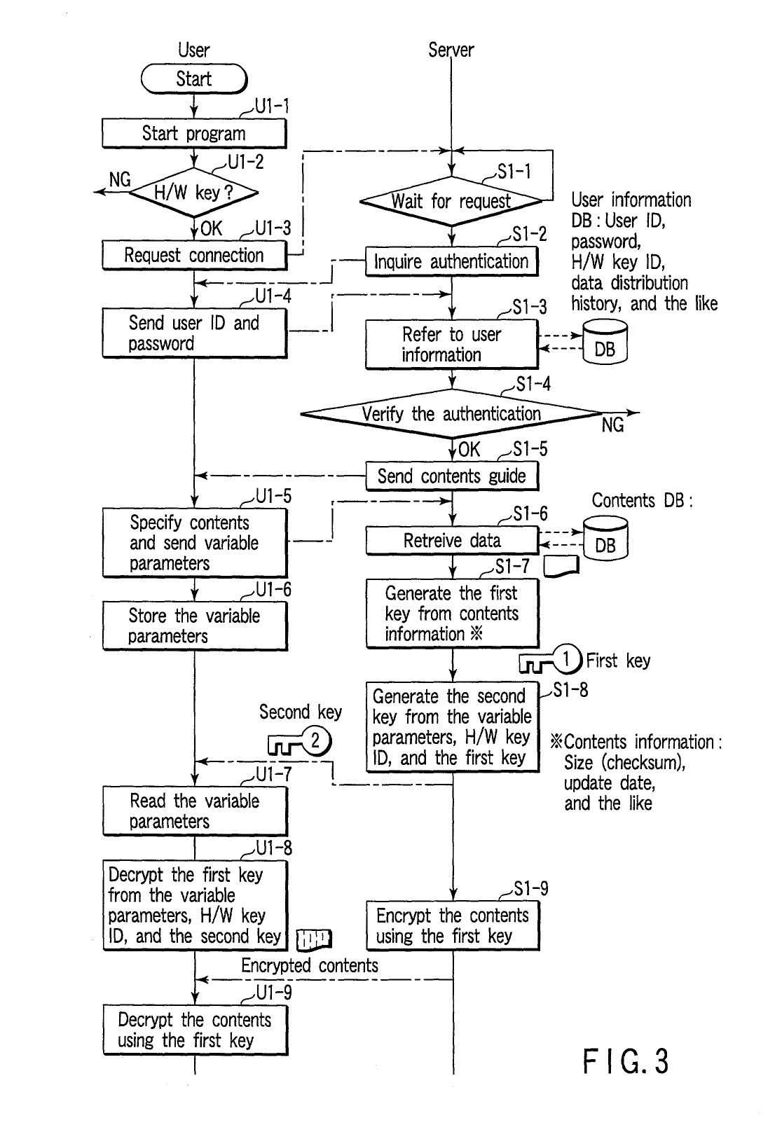

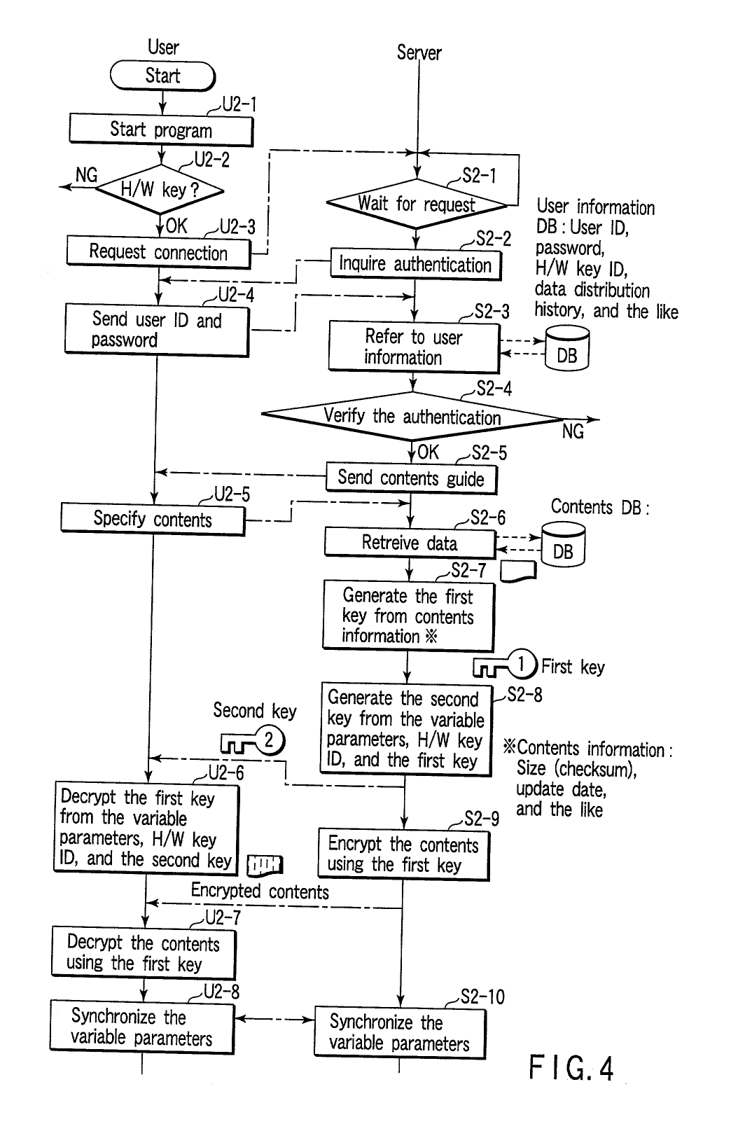

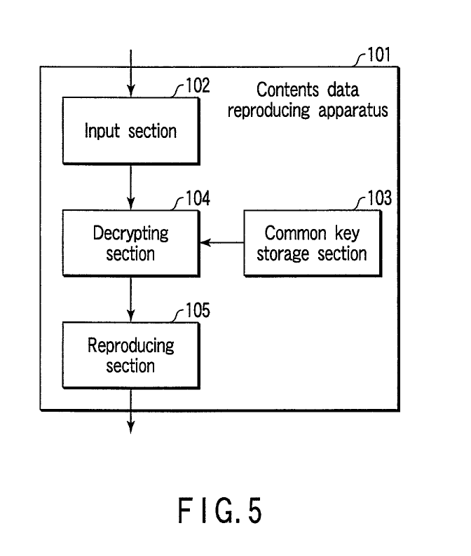

FIG. 3 is a flowchart for the operation of encryption and decryption in the first embodiment. It is premised that the user has contracted with an information provider and received a user ID, a password, and a H/W key for operating a user terminal. It is premised that the information provider has stored the user ID, password, and H/W key information for each user in a server.

In step U1-1, the program in the user terminal 12 is started. If, in step U1-2, it is verified that the H/W key 27 has been inserted in the peripheral I/F 26 of the user terminal 12, a connection to the server 1 is requested in step U1-3. In step S1-1, the server 11 is always waiting for a request for connection from the user terminal 12. If there is a request for connection from the user terminal 12, the server 11 urges the user terminal 12 to make authentication in step S1-2. The user requested for authentication inputs the user ID and password into the user terminal 11 in step U1-4, and sends them to the server 11. In step S1-3, the server 11 retrieves the user's user ID, password, H/W key ID, and the like at the user information database. The server 11, in step S1-4, verifies whether the retrieved user ID and password coincide with the user ID and password received from the user terminal 12. If the former coincide with the latter, the server 11 sends a guide, such as a list of contents to be distributed, to the user terminal 12 in step S1-5. In step U1-5, the user specifies the desired contents for distribution and the user terminal 12 sends the contents specifying data together with variable parameters to the server 11. In addition, the user terminal 11 stores the variable parameters in step U1-6.

The variable parameters mean parameters differing from one user terminal 11 to another and each time the terminal is used. They include the number of distributions of contents data, the preceding transmission time, the preceding transmission date, and the number of connections.

The server 11, in step S1-6, retrieves the contents body and contents information at the contents database on the basis of the contents specifying data sent from the user terminal 12.

The contents information is information that specifies each content, including the content size and the preceding update date of the content.

The server 11 generates a first key from the retrieved contents information in step S1-7. Next, in step S1-8, the server 11 generates a second key from the variable parameters received from the user terminal 12, the user's H/W key ID retrieved from the user information database, and the generated first key, and sends the second key to the user terminal 12.

The user terminal 12, in step U1-7, reads the variable parameters. In step U1-8, the user terminal 12 receives the second key from the server 11 and decrypts the first key from the read-out variable parameters, the second key, and the H/W key ID.

The server 11, in step S1-9, encrypts the contents body to be distributed by using the first key and sends the encrypted contents body to the user terminal 12.

In step U1-9, the user terminal 12 decrypts the encrypted contents data body received from the server 11 by using the decrypted first key.

The order of the above operations is not limited to the order in the first embodiment. The order may be changed as long as the change has no adverse effect on the distribution of the contents data between the server 11 and the user terminal 12 and on the encryption and decryption. For instance, step S1-9 may be carried out following step S1-7.

As described above, the second key generated at the server 11 uses not only the fixed generating elements but also the variable parameters differing each time as creating elements. This can prevent the decryption key from being stolen by an illegal invasion, such as a hacker and therefore the contents data from being reproduced illegally.

The user terminal 12 may be further provided with the function of preventing the contents data received from the server 11 from being stored. With this function, the user can reproduce the distributed contents data only once, which makes it possible to charge the user for reproduction according to the number of readings, seeings, or hearings.

(Second Embodiment)

FIG. 4 is a flowchart for the operation of encryption and decryption in a second embodiment of the present invention. A detailed explanation of the same part of the operation as that in the first embodiment will be omitted.

Step U2-1 in which the user starts the program in the user terminal 12 to step S2-5 in which the server 11 sends a guide, such as a list of contents to be distributed, to the user terminal 12 are the same as in the first embodiment.

The second embodiment differs from the first embodiment in that, in step U2-5, the user does not send the variable parameters when the user specifies the contents and sends the contents from the user terminal 12 to the server 11. In addition, the second embodiment differs from the first embodiment in that the user terminal 12 decrypts the contents data in step U2-7 and thereafter, in step U2-8 and step S2-10, the variable parameters are synchronized between the user terminal 12 and the server 11.

With the above-mentioned operation, the variable parameters, part of the elements for generating the second key, are not sent from the user terminal 12 to the server 11 in a series of content distributing operations. As a result, the security is improved further.

The above-mentioned synchronizing process may be carried out at the time different from the time when a connection is made to distribute the contents data.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method for encrypting and decrypting contents data to be distributed from a server to a user terminal through a network, said method comprising:
generating a first key at the server from contents information about the distributed contents data;
generating a second key at the server from a variable parameter, a H/W key ID, and said first key and sending the generated second key to the user terminal;
decrypting the first key at the user terminal from the variable parameter, the H/W key ID, and said second key;
encrypting the contents data to be distributed at the server by using said first key and sending the encrypted contents data to the user terminal; and
decrypting the encrypted contents data at the user terminal by using said decrypted first key.

2. The method according to claim 1, the method further comprising generating the variable parameter at the user terminal and sending the generated variable parameter to the server.

3. The method according to claim 2, wherein the variable parameter used for generating the second key at the server are the variable parameter sent from the user terminal.

4. The method according to claim 1, the method further comprising synchronizing the variable parameter between the user terminal and the server.

5. The method according to claim 4, wherein said synchronization between the user terminal and the server is performed at a time different from a time when the contents data is distributed.

6. A contents data encrypting and decrypting system comprising:
a server, the server comprising;
means for generating a first key from contents information of contents data to be distributed,
means for generating a second key from a variable parameter, a H/W key ID, and said first key, and
means for encrypting the contents data to be distributed by using the first key; and
a user terminal,
the user terminal comprising;
a network interface configured to receive said second key and said encrypted contents data from said server,
means for decrypting the first key from the variable parameter, the H/W key ID, and said second key, and
means for decrypting said encrypted contents data by using said decrypted first key.

7. The contents data encrypting and decrypting system according to claim 6, the system further comprising
means for synchronizing the variable parameter between said server and said user terminal.

8. A user terminal used for encrypting and decrypting contents data to be distributed from a server through a network, the user terminal comprising:
a network interface configured to receive from the server a second key generated from a first key generated from contents information of the contents data to be distributed, a variable parameter, and a H/W key ID, and the contents data encrypted by using said first key; and
a decrypting section configured to decrypt the first key from the variable parameter, the H/W key ID, and said second key, and then decrypt said encrypted contents data by using said decrypted first key.

9. The user terminal according to claim 5, the user terminal further comprising means for synchronizing the variable parameter between the server and the user terminal.
